(19) United States
(12) Patent Application Publication
(10) Pub. No.: US 2009/0096611 A1
(43) Pub. Date: Apr. 16, 2009

(54) MOBILE RADIO FREQUENCY IDENTIFICATION ANTENNA SYSTEM AND METHOD

(75) Inventor: Donald Edward JONES, Jupiter, FL (US)

Correspondence Address: Christopher & Weisberg, P.A., 200 East Las Olas Boulevard, Suite 2040, Fort Lauderdale, FL, 33301, US

(73) Assignee: SENSORMATIC ELECTRONICS CORPORATION, Boca Raton, FL (US)

(21) Appl. No.: 11/872,994

(22) Filed: Oct. 16, 2007

(51) Int. Cl. G08B 13/181

(52) U.S. Cl. 340/572.7

(57) ABSTRACT

An apparatus, system and method for creating a repositionable radio frequency identification (“RFID”) interrogation zone to locate objects in which the apparatus, system and method includes a radio frequency (“RF”) antenna that transmits a RFID interrogation signal to establish the repositionable RFID interrogation zone and receives a reflected RFID reply signal from at least one RFID tag associated with an object in the repositionable RFID interrogation zone, and a handle that is coupled to the RF antenna. The apparatus, system and method can further include a handle being rotatably coupled to the RF antenna about a pivot point that allows angular position adjustment of the RF antenna to the handle, with a trigger switch coupled to the handle.

### CROSS-REFERENCE TO RELATED APPLICATION

n/a

### STATEMENT REGARDING FEDERALLY SPONSORED RESEARCH OR DEVELOPMENT

n/a

### FIELD OF INVENTION

The present invention relates to radio frequency identification (“RFID”) systems and more particularly to a system and method for detecting the presence of items in a RFID interrogation zone using a portable RFID antenna.

### BACKGROUND OF THE INVENTION

Radio frequency identification (“RFID”) is a term used to describe technologies that use radio waves to automatically identify objects or people. RFID systems are used for many applications such as managing inventory, electronic access control, security systems, automatic identification of cars on toll roads, article surveillance, etc. RFID implementations are accomplished in several ways. The most popular implementation involves storing one or more pieces of information including for example, a unique identifier that identifies an object or a person, and perhaps other information, on a microchip in communication with a transponder. This arrangement is commonly referred to as a RFID marker or RFID tag. RFID systems may be used to track or monitor the location and/or status of articles or items to which a RFID tag is applied.

An antenna, sometimes packaged with a transceiver and decoder, provides the ability to receive and convert the radio waves reflected back from the RFID tag into digital information that can then be passed on to computers for processing. The antenna, the transceiver and the decoder are often collectively referred to as the RFID reader. The RFID reader enables transmission of an interrogation signal to the RFID tag to obtain identification information. Based on the interrogation signal, the RFID reader also receives signals from the tag bearing data such as the identification information. The region in which a RFID reader can detect the presence of RFID tags is referred to herein as an “interrogation zone”. In most RFID systems, the RFID readers are stationary and fixed at a certain location, such as a detection pedestal or a building doorway or entrance. These stationary RFID readers create stationary interrogation zones.

Signals received by RFID readers in the form of backscatter modulation are typically analyzed in order to obtain tag identification information from the interrogated tags. While this leads to readers that are designed to be sensitive to reflected energy, normally, extraneous reflections unrelated to the identity of the tag, are removed or mitigated in some way by the receiver portion of the RFID reader.

In some RFID systems, items that are to be monitored are stacked near each other or one on top of another, on predominately metallic shelves and racks. Often, an interrogation signal generated by a RFID reader is significantly attenuated or blocked and fails to reach the RFID tags attached to the items to be monitored. For example, in a music store, a shelf might contain many compact discs; however, the interrogation signal from a stationary reader or even a mobile reader may not penetrate through the entire stack of compact discs and therefore leading to inaccurate inventory counts.

Current mobile RFID readers are typically hybrid bar code scanners that have been adapted or modified to add RFID reader capability as an additional feature to EAS tag deactivation and/or bar code scanning. These hybrid scanners are costly, non-modular and typically have limited RF power output due to battery charge capacity and antenna size.

What is needed is a method and system that can be used to accurately locate tags the within a RFID interrogation zone especially when the items are stacked one on top of the other or placed on metallic racks and shelving.

### SUMMARY OF THE INVENTION

In accordance with one aspect, the present invention advantageously provides an apparatus for creating a repositionable radio frequency identification (“RFID”) interrogation zone to locate objects in which the apparatus includes a radio frequency (“RF”) antenna that transmits a RFID interrogation signal to establish the repositionable RFID interrogation zone and receives a reflected RFID reply signal from at least one RFID tag associated with an object in the repositionable RFID interrogation zone. The apparatus can further include a handle that is coupled to the RF antenna. The apparatus can further include a handle that is rotatably coupled to the RF antenna about a pivot point that allows angular position adjustment of the RF antenna to the handle, and includes a trigger switch coupled to the handle.

In accordance with another aspect, the present invention provides a method for locating and managing tagged objects in a RFID interrogation zone using a portable RFID antenna that includes establishing a repositionable RFID interrogation zone using a portable RFID antenna coupled to a handle. An RFID tag is queried using the RFID antenna, in which the RFID tag is coupled to the object and has tag information.

In accordance with another aspect, the present invention provides a RFID system for managing a plurality of RFID tags coupled to corresponding items in which the RFID system has a handheld repositionable RFID antenna unit. The handheld repositionable RFID antenna operates to communicate with at least one of the RFID tags having tag information including at least a RFID identifier uniquely identifying the corresponding item. A RFID tag reader is in electrical communication with the RFID antenna unit.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a diagram of a RFID system constructed in accordance with the principles of the present invention;

FIG. 2 is a diagram of another embodiment of a RFID system constructed in accordance with the principles of the present invention;

FIG. 3 is a diagram of a portable RFID antenna of the system 100 of FIG. 1 in accordance with the principles of the present invention;

FIG. 4 is a is a diagram of the portable RFID antenna of FIG. 3 showing the antenna rotated with respect to the handle;

FIG. 5 is a is a diagram of the portable RFID antenna of FIG. 3 showing the antenna rotated to another orientation with respect to the handle; and

FIG. 6 is a flowchart illustrating an exemplary method for managing RFID tags using a portable RFID antenna in accordance with the principles of the present invention.

### DETAILED DESCRIPTION OF THE INVENTION

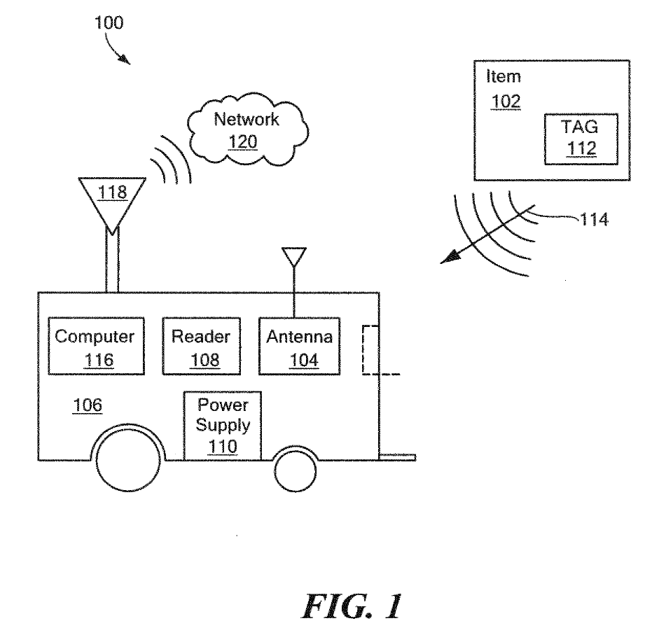

Referring now to the drawing figures in which like reference designators refer to like elements, there is shown in FIG. 1 a diagram of an exemplary system constructed in accordance with the principles of the present invention and designated generally as “100”. System 100 manages at least one item 102 using a portable Radio Frequency Identification (“RFID”) antenna 104. More specifically, system 100 facilitates any person or entity using RFID to track, locate, identify, process, filter, or otherwise manage a plurality of items 102 through RFID communications by using a mobile unit 106 coupled with one or more RFID antennas 104 that can include hand deployable RFID antennas 104.

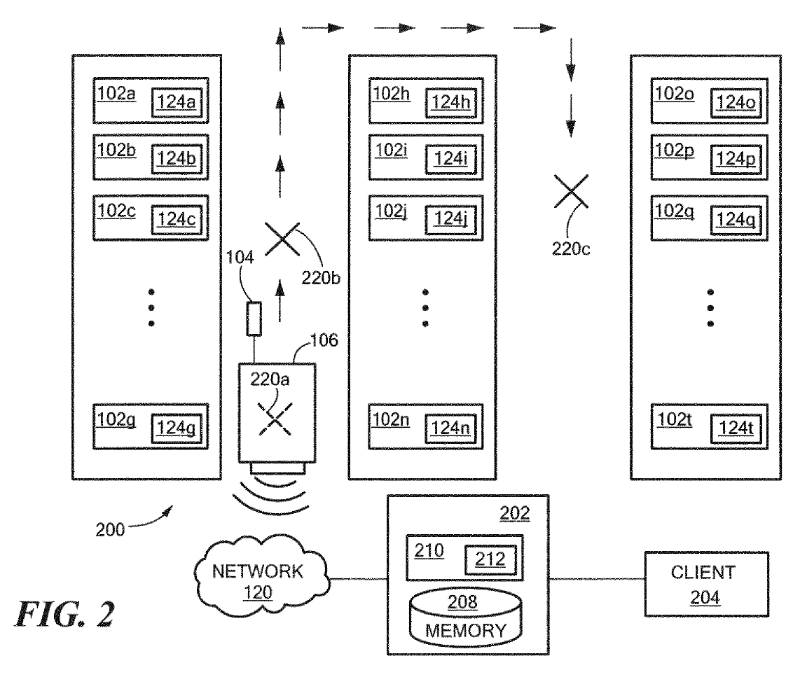

System 100 can be implemented in all or a portion of any appropriate location including, for example, a shopping center, grocery store, factory, or warehouse (as illustrated in more detail in FIG. 2). These locations may include thousands or even millions of items 102 stored across tens of thousands of square feet. Accordingly, these large locations may be difficult to automatically inventory or locate individual items 102 because, when items 102 are stacked one on the other, especially on metallic racks or shelving, the interrogation signal can be significantly attenuated or blocked. Moreover, interference from other electromagnetic devices, other readers, other tags or markers and the like can mask the reply signal of a tag, thereby causing an erroneous inventory count by system 100. Of course, system 100 may be of any size or configuration that includes one or more tagged items 102 and can be scanned using mobile unit 106, which includes a hand-held RFID antenna 104. For example, the exemplary system 100 shown in FIG. 1 includes mobile unit 106, coupled with at least a RFID antenna 104, a RFID tag reader 108, and an onboard power source 110. Mobile unit 106 communicates with RFID tagged items 102.

As used herein, items 102 may each be any component, device, commodity or other product or article operable to be tagged using RFID tags 112. For example, these items 102 may include electronic devices, luggage, groceries, boxes, or various others. These tagged items 102 are associated with a plurality of electronic characteristics including, for example, serial number, color, price, manufacturer, and other identifying data using tag information 114. Typically, this tag information 114 is associated with item 102 by being stored or referenced in RFID tag 112. Optionally, the tag information 114 may be stored in a database (not shown).

RFID tag 112 is affixed to item 102. Generally, RFID tag 112 is any component operable to communicate radio signals or other wireless communications that include identifying information 114. RFID tag 112 is typically a small component that may be adhered, attached, or otherwise secured to item 102. In certain embodiments, RFID tag 112 may be secured in such a way that removing it will disable tag 112 or activate some other security feature. RFID tag 112 may be embedded into the item 102 and may therefore not be visible.

Moreover, each tag 112 may be of a different size or configuration or arranged to match the appropriate item 102. RFID tag 112 may be active or passive as appropriate. The active RFID tag 112 is generally a radio transmitter with a power supply and suitable memory (such as one or more megabytes). RFID tag 112, when of the active type, usually has ranges of dozens of meters and is in an “always on” state (when powered on). Generally, a passive RFID tag 112 is a smaller device that does not require a power supply and includes less memory. The required power is typically provided by the radio signal, which activates the passive RFID tag 112 when information is requested. Whether active or passive, RFID tag 112 is operable to transmit any suitable radio signal. For example, system 100 may be or include a low frequency system (125-134 kHz), high frequency system (13-14 MHz), a UHF system (850-950 MHz), a microwave system (2.4 GHz), another suitable frequency, or any combination thereof compatible with a particular mobile unit 106 and operable to transmit RFID information 114. This information 114 may be stored in local tag memory or other coupled memory. In other words, RFID tag 112 may automatically supply users of system 100 with electronic information 114 about item 102. This information 114 may include any data that is operable to be dynamically filtered based on certain criteria or parameters. The term “dynamically,” as used herein, generally means that certain processing is determined, at least in part, at run-time based on one or more variables. The term “automatically,” as used herein, generally means that the appropriate processing is substantially performed by at least part of system 100. It should be understood that “automatically” further includes any suitable user interaction with system 100 or mobile unit 106 without departing from the scope of this disclosure.

Mobile unit 106 is any device operable to physically travel or relocate among or around a plurality of items 102 such that RFID antenna 104 may be considered relatively portable. For example, mobile unit 106 may be a shopping cart, a golf cart, a dolly, a flatbed, a forklift, a robot, an airport shuttle cart, an airport luggage cart, or any other suitable vehicle or mobile mechanism of any appropriate size to accommodate at least one RFID antenna 104. In certain embodiments, mobile unit 106 may be a hand-pushed device or an electronic device operable to automatically relocate according to present commands or algorithms or a dynamically determined path. Mobile unit 106 includes at least one RFID antenna 104, RFID reader 108, and onboard power source 110. Generally, power source 110 may be any suitable battery or fuel source operable to (at least partially) drive mobile unit 106 and power RFID antenna 104 and RFID tag reader 108. Illustrated mobile unit 106 may also include on-board computer 116 with graphical user interface 120, and a control switch 122 to add additional functionality to mobile unit 106 or for ease or efficiency of the operator; but these components are optional and may not be present in some mobile units 106.

RFID antenna 104 is any antenna constructed in accordance with the principles of the present invention that is operable to communicate using RFID communications. For example, RFID antenna 104 may be implemented as a portable antenna and operable to communicate with RFID tags 112. RFID antenna 104 may communicate with mobile unit 106 using any appropriate technique including using wired or wireless communications or directly embedding RFID antenna 104 in mobile unit 106. Moreover, each antenna 104 may be oriented in a particular direction. For example, mobile unit 106 may have a first antenna 104 attached to one side of mobile unit 106 and a second antenna 104 that is a portable hand-held antenna on the other side. This placement would allow the first fixed antenna 104 to be oriented in one direction while allowing the second portable hand-held antenna 104 to be deployed as needed and thereby allowing mobile unit 106 to more efficiently collect tag information 114 for a given interrogation zone. In another example, mobile unit 106 includes five antennas 104, e.g., one facing in each of four directions and one portable hand-held antenna 104. Regardless of the number or orientation, each RFID antenna 104 is part of or communicably coupled with RFID reader 108.

Mobile unit 106 uses at least one RFID tag reader 108 to monitor, query, or otherwise process data from RFID antenna 104. RFID tag reader 108 is any device, such as a transceiver, operable to communicate with RFID tags 112 through one or more RFID antennas 104. As described in more detail with reference to FIG. 2, RFID tag reader 108 may also be compatible to communicate, via wireless or wireline signals, with other computers such as onboard or local computer 116 and remote server 202. In certain embodiments, RFID tag reader 108 operates at one frequency compatible with RFID tags 112 or at numerous frequencies to accommodate numerous disparate RFID tags 112, as well as with server 202 (see FIG. 2) for example. RFID tag reader 108 may also include an encoder/decoder or other secured communication device. In certain embodiments, RFID tag reader 108 is communicably coupled with computer 116.

Onboard computer 116 is any local processing device (such as a laptop, blade, personal data assistant (“PDA”), etc.) operable to manage, filter, or otherwise process RFID tag information 114. Local computer 116 may be communicably coupled with mobile unit 106 using any appropriate technique. For example, local computer 116 may be a laptop that rests on top of mobile unit 106, a PDA carried by the operator of mobile unit 106, or a processing device embedded within mobile unit 106. In certain embodiments, computer 116 may be wirelessly connected to other computers for subsequent processing or viewing of tag information 114. Moreover, computer 116 includes a central processing unit, memory, input/output devices and communication hardware and may also execute any appropriate off-the-shelf, customized, or proprietary applications. For example, illustrated computer 116 can include software and/or firmware operable to perform the processes described herein.

For example, this software may be written or described in any appropriate computer language including C, C++, Java, and others known or developed in the art. In certain embodiments, this software may also include or be communicably coupled with an onboard database for storing the collected RFID tag information 114. In some of these embodiments, local database may be a relational database comprising one or more tables described in terms of SQL statements or scripts. In other embodiments, the local database may store or define various data structures as text files, eXtensible Markup Language (“XML”) documents, Virtual Storage Access Method (“VSAM”) files, etc. In certain embodiments, computer 116 also includes or is communicably coupled with a graphical user interface (“GUI”).

In most cases, a GUI comprises a graphical user interface operable to allow the operator or other user of mobile unit 106 to interface with computer 116 to view information associated with the one or more items 102. Generally, GUI provides the user of mobile unit 106 with an efficient and user-friendly presentation of data, namely information from RFID tags 112. A GUI may comprise a plurality of frames or views having interactive fields, pull-down lists, and buttons operated by the user. In one embodiment, the GUI communicates one or more web pages presenting information for at least a portion of the queried RFID tags 112. The GUI may also present summarized or filtered information 114. It should be understood that the term graphical user interface may be used in the singular or in the plural to describe one or more graphical user interfaces and each of the displays of a particular graphical user interface. Further, a GUI can include any graphical user interface (such as a generic web browser, a touch screen, or a text interface), that processes information in system 100 and efficiently presents the information to the operator. In certain embodiments, computer 116 may receive commands from the operator through the GUI, as well as other input devices (such as a mouse or keyboard).

Mobile unit 106 also includes wireless networking subsystem 118 to allow mobile unit 106 and its components, e.g., reader 108 and/or computer 116 to engage in wireless communication with server 202 (FIG. 2) via communication network 120. In such a case, communication network 120 is arranged to support wireless communications.

In one aspect of operation as noted above, RFID tag 112 is affixed to item 102 at any suitable time such as, for example, at the time of manufacture or arrival at a warehouse. RFID tag 112 may be secured using screws, welding, adhesive, or through other techniques. Before or after being affixed, RFID tag 112 is encoded or otherwise loaded with certain tag information 114. For example, RFID tag 112 may be programmed with this information using a tag programming station. As described above, this information 114 may include a serial number, a RFID identifier, an inventory number or any other identifying or inventory characteristics. Once sufficiently loaded with certain information 114, then RFID tag 112 is operable to communicate this data to RFID tag reader 108 through RFID antenna 104 in response to or based on queries. For example, an operator may push or direct mobile unit 106 to move among various remote locations to track or inventory tagged items 102. In one burst or over a (relative) time period, RFID tag 112 communicates this data 114 to RFID tag reader 108 through portable RFID antenna 104. Using any appropriate technique, RFID tag reader 108 directly or indirectly presents or otherwise communicates this information to the operator or a local program module for viewing or processing. For example, RFID tag reader 108 may present the information through the resident GUI, create a report or other output through computer 116, or communicate this information to server 202 (see FIG. 2) for subsequent processing and presentment.

FIG. 2 is a block diagram illustrating at least a portion of item management system 200 for managing one or more RFID tagged items 102. At a high level, item management system 200 is operable to manage, process, or otherwise track a plurality of items 102 based on information retrieved from each item's RFID tag 112 using portable mobile unit 106. In other words, system 200 is any networked, wireless, and/or other RFID-compatible environment and may be or include a store, manufacturing plant, a warehouse, a shipping point, a dealership, and/or other item locations operable to automatically collect and process information from the RFID tags 112.

For example, illustrated system 200 is a warehouse comprising a plurality of shelved items 102, one or more RFID-enabled mobile units 106, and a server 202, client 204, and/or other remote computing device for processing the retrieved information. In this example, items 102 may be stacked in such a way as to make automatic inventory unfeasible or inefficient. Continuing this example, the warehouse may provide one or more employees or other personnel with one or more RFID-enabled mobile units 106 for efficiently processing items 102. Using the mobile unit 106, the operator may push, direct, or command mobile unit 106 to a first location (e.g., location 220a) for querying any items 102 within range of antenna 104. Another hand-held antenna 104 can be deployed to verify that all items 102 are located, especially where items 102 are stacked or shelved on metallic racks. Mobile unit 106 may then move or relocate from location (e.g., location 220b) to location (e.g., location 220c) as desired. Once mobile unit 106 collects any suitable amount of tag information 114, this information may be communicated to server 202 or client 204 for subsequent processing or viewing.

Server 202 is any computer that can perform the functions described herein and may be in data communication with any number of clients 204 and/or other network devices such as switches or routers, printers, docking stations, or others. For example, server 202 may be a blade server, a mainframe, a general-purpose personal computer (“PC”), a Macintosh, a workstation, a Unix-based computer, a web or email server, or any other suitable device. FIG. 2 only illustrates one example of computers that may be used with the invention. For example, although FIG. 2 illustrates one server 202 that may be used with the invention, system 200 can be implemented using computers other than servers, as well as a server pool. Computers other than general purpose computers as well as computers without conventional operating systems can be used. As used in this document, the term “computer” is intended to encompass a personal computer, workstation, network computer, or any other suitable processing device. Computer server 202 may be adapted to execute any operating system including Linux, UNIX, Windows or any other suitable operating system so long as server 202 remains operable to process native or filtered RFID data. Server 202 typically includes an interface for communicating with the other computer systems, such as client 204 and/or mobile unit 106 over network 120 in a client-server or other distributed environment. Generally, the interface comprises logic encoded in software and/or hardware in a suitable combination and operable to communicate with network 120. More specifically, the interface may comprise software supporting one or more communications protocols associated with communications network 120 or hardware operable to communicate physical signals. In short, server 202 may comprise any computer with software and/or hardware in any combination suitable to receive or retrieve RFID information 114 from RFID tags 112 (via RFID tag reader 108), generate web pages or other output based on the item RFID data 114, and communicate the output to users of one or more clients 204 via network 120.

Network 120 facilitates wireless or wireline communication between computer server 202 and any other computing device. Network 120 may communicate, for example, Internet Protocol (“IP”) packets, Frame Relay frames, Asynchronous Transfer Mode (“ATM”) cells, voice, video, data, and other suitable information between network addresses. Network 120 may include one or more local area networks (“LANs”), radio access networks (“RANs”), metropolitan area networks (“MANs”), wide area networks (“WANs”), all or a portion of the global computer network known as the Internet, and/or any other communication system or systems at one or more locations.

Server 202 further includes memory 208 and processor 210. Memory 208 may include any memory or database module and may take the form of volatile or non-volatile memory including, without limitation, magnetic media, optical media, random access memory (“RAM”), read-only memory (“ROM”), removable media, or any other suitable local or remote memory component. Memory 208 typically includes collected RFID information 114, but may also include any other suitable data including security logs, web logs, HTML pages and templates, word documents, emails, and others.

Server 202 also includes processor 210. Processor 210 executes instructions and manipulates data to perform the operations of server 202 and may be, for example, a central processing unit (“CPU”), an application specific integrated circuit (“ASIC”) or a field-programmable gate array (“FPGA”). Although FIG. 2 illustrates a single processor 210 in server 202, multiple processors 210 may be used according to particular needs, and reference to processor 210 is meant to include multiple processors 210 where applicable. In certain embodiments, processor 210 executes one or more processes associated with RFID application 212.

RFID application 212 includes any hardware, software, firmware, or combination thereof operable to collect or receive RFID information 114 from mobile units 106. For example, RFID application 212 may receive RFID information 114, process it according to various algorithms, and store the processed data in memory 208. The processing may include mapping the various tagged items 102 using the RFID technology, embedding information 114 for each tagged item 102 in a webpage, summarizing collected RFID data, and such. RFID application 212 may be written or described in any appropriate computer language including C, C++, Java and others known or developed in the art. In one embodiment, RFID application 212 may be referenced by or communicably coupled with applications executing on client 204 or mobile unit 106.

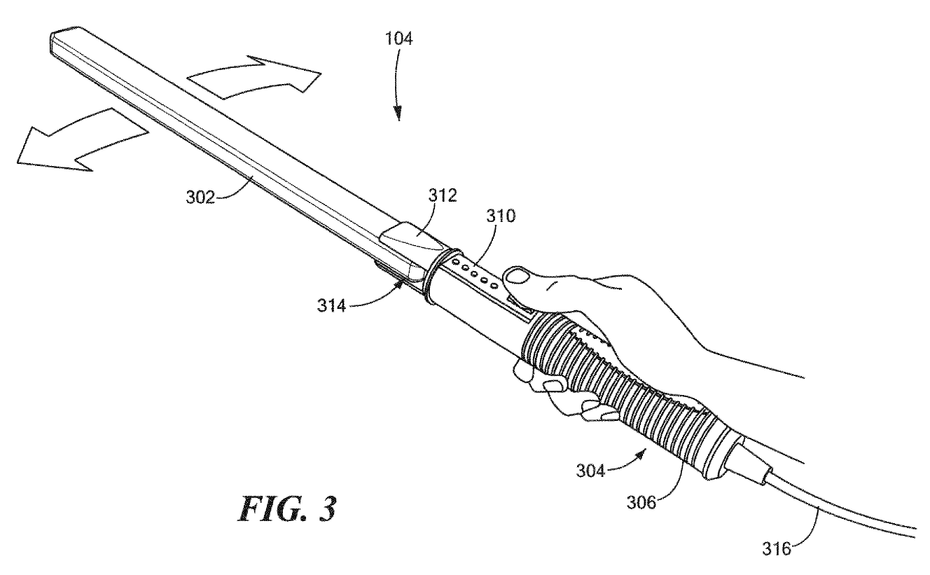

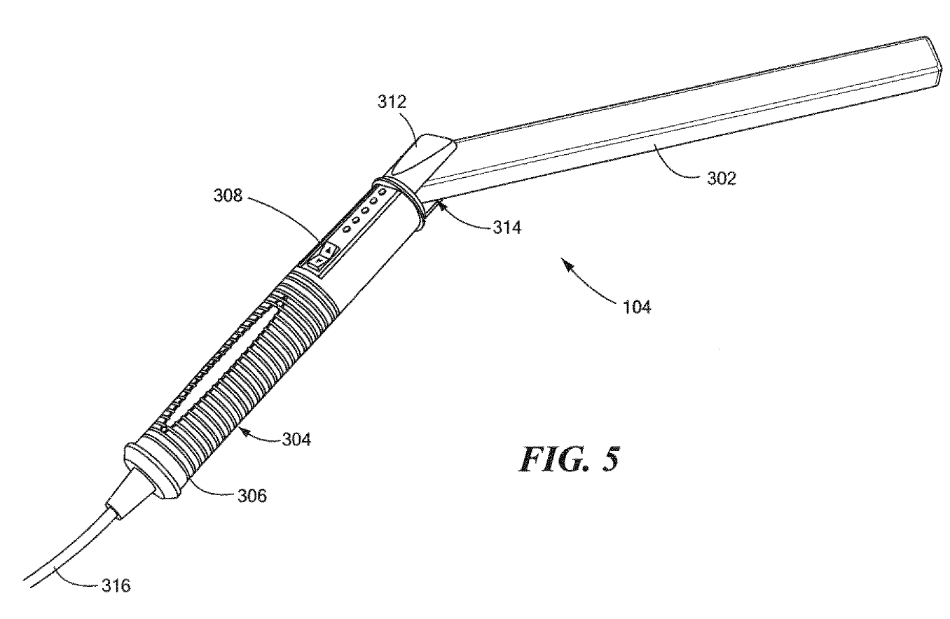

FIG. 3 illustrates an embodiment of a portable antenna 104 constructed in accordance with the present invention. In this embodiment, portable antenna 104 is an adjustable hand-held wand that can be used to locate items 102 that may be stacked one on top of another or on metallic racks or shelving. As illustrated, portable antenna 104 includes adjustable antenna portion 302 and handle portion 304. For example, adjustable antenna portion 302 can be six to eighteen inches long, weigh from one to two pounds, and may generate RF interrogation energy along its entire length. Handle portion 304 includes hand grip 306, which can be contoured or textured to improve gripping of portable antenna 104, human actuable switch 308, power indicator LEDs 310 and adjustment pivot point 312. Human actuable switch 308 (see FIG. 5) is configured to provide RF power to the antenna portion 302 and to adjust the level of this RF power. For example, in the case where human actuable switch 308 is a trigger switch, by depressing the trigger switch 308 in a first direction, RF power is applied to the antenna portion 302. If the user continues to depress the trigger switch in the first direction, the amount of RF power is increased to the antenna portion 302, and a corresponding number of power indicator LEDs 310 are illuminated to give the user a visual indication of RF power levels. Human actuable switch 308 is not limited to a trigger switch, but can be a thumbwheel or lever that allows continuously variable adjustment of RF power output by the antenna portion 302.

In the illustrated example, there are five LEDs or other indicators 310 of power, but there can be more or fewer LEDs or other indicators 310 depending on the level of granularity desired for the portable antenna 104. In the illustrated example, the granularity for each LED can be implemented by software, hardware or a combination thereof.

Additionally, handle portion 304 includes a housing 312 that defines a recess at a first end of the housing 312. An adjustment pivot point 314 resides in the recess of the first end of housing 213 to rotatably couple the antenna portion 302 to the handle portion 304. This advantageously provides a user the capability to adjust the angular relationship between the handle portion 304 and the antenna portion 302 to locate and identify stacked items 102. In the illustrated example, the portable antenna 104 further includes a tether cable or umbilical 316, which can be a variable length of flexible cable that provides an electrical connection with the RF source and the reader 108. Tether cable 316 also provides for communications between portable antenna 104 and reader 108, including control functions. In the exemplary embodiment illustrated in FIG. 3, the cable 316 is coupled to the second end of housing 312, which is opposite the recess locate at the first end of housing 312. It should be noted that in another embodiment, it is anticipated that portable antenna 104 can include its own power source, i.e., battery and can be wirelessly connected to the reader 108.

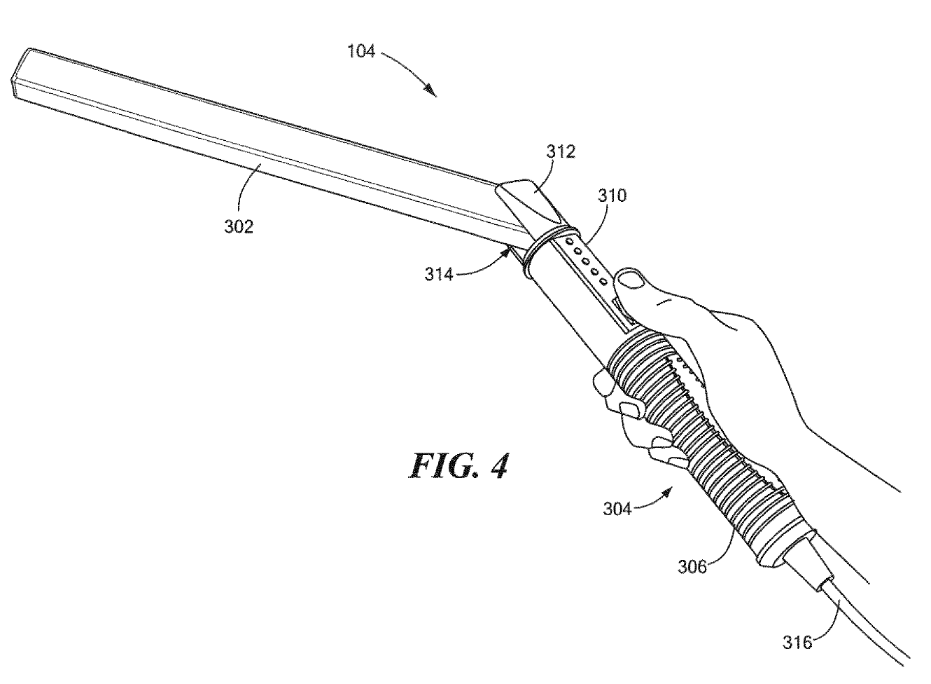

FIG. 4 illustrates portable antenna 104 having its adjustable antenna portion 302 at approximately a 120 degree angle in relation to the handle portion 304. FIG. 5 illustrates portable antenna 104 having its adjustable antenna portion 302 at approximately a 90 degree angle in relation to the handle portion 304. It is understood that the angular relationships shown in FIGS. 4 and 5 are exemplary and it is contemplated that other angular relationships can be used. It is contemplated that handle portion 304 and antenna portion 302 can be positionable with respect to one another using a plurality of detents or in a continuously variable manner.

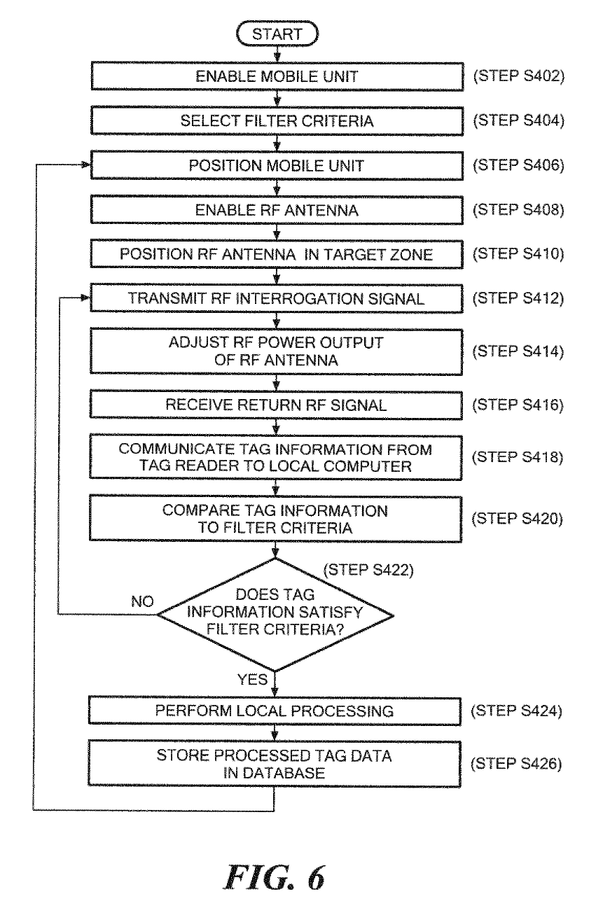

FIG. 6 is a flowchart illustrating an example method 400 for managing RFID tags 112 using a portable RFID antenna 104. Method 400 is described with respect to system 100 and, in particular, to a warehouse including local or remote server 202. However, any other suitable system or portion of a system may use appropriate embodiments of method 400 to retrieve and process RFID information to manage a plurality of RFID tagged items 102. Generally, method 400 describes an operator pushing or directing mobile unit 106 from one location 220 to another such that one or more RFID tags 112 may be queried from a relatively close distance.

Example method 400 begins at step S402, when mobile unit 106 is enabled, powered on, or otherwise initialized. For example, the operator may switch a control switch on a handle of mobile unit 106 from “off” to “on”. This switch may power on or enable the onboard power source 110, RFID tag reader 108, and/or other components of mobile unit 106. Next, in some embodiments, filter criteria are identified for subsequent filtering of collected tag information 114 at step S404. At step S406, mobile unit 106 is located at a first location 220a. Of course, if mobile unit 106 is already at a desired first location 220a, then the relocation may merely be a confirmation of the location 220. When mobile unit 106 is actually relocated, this movement may be through any technique appropriate for mobile unit 106. For example, the operator may hand-push mobile unit 106 to the desired location 220. In another example, the operator may select a predetermined location using computer 116 and its GUI. In yet another example, mobile unit 106 may automatically relocate using a predetermined route loaded in computer 116 or may dynamically determine a route based on shelving, sensors, or other obstacles and input.

Once mobile unit 106 is present at the desired location 220, then RF antenna element 104 is enabled at step S408 and the RF antenna element 104 is positioned in a target zone to query for objects having a RFID tag 112 (step S410). A RFID tag reader 108 transmits an interrogation signal via the RF antenna element 104 (step S412) that will create a repositionable interrogation zone. The user can vary the size and strength of the repositionable interrogation zone by adjusting the RF power to the RF antenna element 104 (step S414). For example, when a user believes that some tags within repositionable interrogation zone have not received a query signal from RFID tag reader 108, the RF power output can be increased to overcome electromagnetic interference by other devices or to penetrate stacked boxes and the like, to reach all the tags the repositionable interrogation zone.

At step S416, the RFID tag reader 108 can transmit a subsequent query via the RF antenna element 104 to a first RFID tag 112 within range of RFID antenna 104 and receives a return RF signal. This query may comprise a request, retrieval, or any other communication that results in tag information 114 at RFID tag reader 108. At step S418, the tag information 114 is communicated to local computer 116. For example RFID tag reader 108 may transmit the collected information 114 to computer 116 via a wireless or wireline link as appropriate. At step S420, computer 116 compares tag information 114 to the filter criteria. If the information satisfies (or fails to satisfy as appropriate) the criteria at decisional step S422, then processing proceeds to step S412. Otherwise, tag information 114 is communicated to example middleware for any suitable local processing at step S424. At step S426, the collected or processed information 114 is stored in a local database or other memory or data module.

Next, RFID tag reader 108 or the operator determines if there are more desired RFID tags 112 or tagged items 102 within range of portable RFID antenna 104 and can query the addition tags, or just relocate the mobile unit 106 to its next location by returning to step S406.

The preceding flowchart focuses on the operation of example systems 100 and/or 200 described in FIGS. 1 and 2 as these example diagrams illustrate various functional elements that implement some or all of the preceding techniques for managing tagged items using portable RFID antenna 104. However, as noted above, mobile unit 106, systems 100, and/or 200 can use any suitable combination and arrangement of functional elements for providing these operations, and these techniques can be combined with other techniques as appropriate. Further, various changes may be made to the preceding flowcharts. In other words, many of the steps in these flowcharts may take place simultaneously and/or in different orders than as shown. For example, while method 400 describes the steps occurring serially, instead mobile unit 106 may be concurrently moving and querying. Moreover, these systems may implement methods with additional steps, fewer steps, and/or different steps, so long as the methods remain appropriate.

The present invention can be realized in hardware, software, or a combination of hardware and software. An implementation of the method and system of the present invention can be realized in a centralized fashion in one computing system or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general-purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A mobile handheld apparatus for creating a repositionable radio frequency identification (“RFID”) interrogation zone to locate objects, the apparatus comprising:
a radio frequency (“RF”) antenna, the RF antenna transmitting a RFID interrogation signal to establish the RFID interrogation zone and receiving a reflected RFID reply signal from at least one RFID tag associated with an object in the RFID interrogation zone; and
a handle coupled to the RF antenna.

2. The apparatus of claim 1, wherein the handle is rotatably coupled to the RF antenna about a pivot point to allow angular position adjustment of the RF antenna with respect to the handle.

3. The apparatus of claim 1, further comprising a human acutuable switch coupled to the handle.

4. The apparatus of claim 3, wherein the human actuable switch controls RF power output of the RF antenna.

5. The apparatus of claim 1, further comprising a RF power level indicator coupled to one of the handle and the RF antenna.

6. The apparatus of claim 5, wherein the RF power level indicator is at least one LED.

7. The apparatus of claim 1, further comprising a cable coupled to the handle, the cable supplying RF energy to the RF antenna.

8. A method for locating and managing tagged objects in a radio frequency identification (“RFID”) interrogation zone using a portable RFID antenna, the method comprising:
establishing a repositionable RFID interrogation zone using a portable RFID antenna coupled to a handle; and
querying an RFID tag using the RFID antenna, the RFID tag coupled to the object and having tag information.

9. The method of claim 8, further comprising adjusting the power output of the RFID antenna.

10. The method of claim 9, wherein adjusting the power output of the RFID antenna includes monitoring an amount of actuation of a user actuable device; and
setting the power output based on the amount of actuation.

11. The method of claim 10, further comprising displaying the power output of the RFID antenna on an visual power indicator.

12. The method of claim 8, further comprising adjusting an angular position of the RFID antenna with reference to the handle.

13. The method of claim 8 wherein the angular position is continuously variable.

14. The method of claim 8, further comprising receiving a signal from a queried RFID tag; and
wirelessly communicating the received signal to an RFID reader.

15. A radio frequency identification (“RFID”) system for managing a plurality of RFID tags coupled to corresponding items, the RFID system comprising:
a handheld repositionable RFID antenna unit, the handheld repositionable RFID antenna operating to communicate with at least one of the RFID tags having tag information including at least a RFID identifier uniquely identifying the corresponding item; and
a RFID tag reader in electrical communication with the handheld repositionable RFID antenna unit.

16. The RFID system of claim 15, wherein the handheld repositionable RFID antenna unit includes:
a radio frequency (“RF”) antenna, the RF antenna transmitting a RFID interrogation signal to establish the RFID interrogation zone and receiving a reflected RFID reply signal from at least one RFID tag corresponding to an item in the RFID interrogation zone; and
a handle coupled to the RF antenna.

17. The RFID system of claim 16, wherein the handle is rotatably coupled to the RF antenna about a pivot point to allow angular position adjustment of the RF antenna with respect to the handle.

18. The RFID system of claim 16, further comprising a human actuable RF power switch coupled to the handle, wherein the human actuable trigger switch controls the RF power output of the RF antenna.

19. The RFID system of claim 18, wherein the human actuable switch is a trigger switch.

20. The RFID system of claim 16, further comprising a RF power level indicator coupled to one of the handle and the RF antenna.
